(19) United States
(12) Patent Application Publication
(10) Pub. No.: US 2015/0302482 A1
(43) Pub. Date: Oct. 22, 2015

(54) System, apparatus and method for interactive product placement

(71) Applicant: Alexie A. Vagner, Alpharetta, GA (US)

(72) Inventor: Alexie A. Vagner, Alpharetta, GA (US)

(21) Appl. No.: 14/257,732

(22) Filed: Apr. 21, 2014

(51) Int. Cl. G06Q 30/02; G06Q 30/06

(52) U.S. Cl. CPC G06Q 30/0269; G06Q 30/0635

(57) ABSTRACT

A system for interactive product placement is comprised of a media-commerce server; and a media-commerce application, and can allow a consumer easy access to information about products seen on television, in movies, and other media, and can further allow the consumer to purchase the products in a single transaction executed across multiple external e-commerce systems. A media-commerce server comprises a processor, a non-transitory memory, an input/output component, a content accumulator, a content repository, a content matcher, an aggregated shopping cart, a social media API, and an external web portal. Also disclosed is a method for interactive product placement, comprising: watching media content, matching media content, selecting category, browsing category, selecting product items, and purchasing product items.

### CROSS-REFERENCE TO RELATED APPLICATIONS

N/A

### FIELD OF THE INVENTION

The present invention relates generally to the field of product placement, and more particularly to devices and methods to allow convenient online retail in direct association with product placement advertising.

### BACKGROUND OF THE INVENTION

Product placement, also often referred to as embedded marketing, is a form of audiovisual advertising, wherein products or services are featured within a movie, show, video game, or television program, and may be directly or indirectly part of a storyline.

Many surveys have shown that product placement is effective, and can have significant influence on sales and people's perception of a product or brand. However, product placement operates mainly via indirect effects and it can be difficult to measure the direct impact of this form of advertising.

Since product placement necessarily must be implemented in a discreet manner that is not disruptive to the normal enjoyment of a show, program, or game, it is normally not feasible to implement an explicit call-to-action offering for the consumer. There are some web and mobile applications that aim to offer purchasing options for specific programs that have been pre-programmed with purchasing options. These applications do not offer the capability of recognizing and presenting purchasing options across all available programming, and are thereby quite limited in the usefulness for consumers.

Despite of the long-term use and known effectiveness of product placement, there are a number of recognized issues with its use. For example, some consumers may not recognize the presence of products embedded in programming, or they may not know how to get more information on what a product is or how to purchase the product. It may require extensive online research to identify the products, and in general, consumers do not have any convenient mechanisms to find comparable products, such as for example of lower cost, higher quality, or made by another brand.

As such, considering the foregoing, it may be appreciated that there continues to be a need for novel and improved devices and methods for interactive product placement.

### SUMMARY OF THE INVENTION

The foregoing needs are met, to a great extent, by the present invention, wherein in aspects of this invention, enhancements are provided to the existing models of product placement and online retail.

In an aspect, the system for interactive product placement can provide information to consumers about products or services that they see on television, in movies, in other media, in the office or on the street, and allow the consumers easy and convenient access to purchasing the products or services.

In various related aspects, the system for interactive product placement can:
a) provide an ability to purchase exact or similar products as seen on TV, in the movies, or in other media;
b) provide an ability to enquire on services related to products seen on TV, in the movies, or in other media;
c) recognize any program on TV via audio and/or by taking a picture of the program. For example, if a consumer is watching a James Bond movie, the system can take a picture of the screen, match the picture with a database and identify that the consumer is watching a particular James Bond movie;
d) recognize products seen in real life encounters, such as while walking on the street, in a shop, etc., and offer opportunities to shop for similar products;
e) aggregate various brands and content providers into one application, and one shopping cart, and provide the capability to purchase several products across several external online retailers in a single shopping transaction;
f) provide APIs, web services, and other protocol mechanisms, to allow content providers, product vendors, and services companies to integrate with the system, for example in order to upload information about programs, shows, products and services, and to process analytics data on consumer activities in relation to product placement campaigns;
g) process media content, such as MP4a, MP3, WAV, and other common formats, by extracting product items, such as consumer items, and then matching images of the product items with a database and creating an association between the media content and the database, thereby building a catalogue of similar products;
h) Process shopping transactions across multiple online shopping systems

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. In addition, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a schematic diagram illustrating a system for interactive product placement, according to an embodiment of the invention.

FIG. 2 is a schematic diagram illustrating a media-commerce server, according to an embodiment of the invention.

FIG. 3 is a schematic diagram illustrating a media-commerce application, according to an embodiment of the invention.

FIG. 4 is a schematic diagram illustrating a computer-implemented method for interactive product placement, according to an embodiment of the invention.

### DETAILED DESCRIPTION

Before describing the invention in detail, it should be observed that the present invention resides primarily in a novel and non-obvious combination of elements and process steps. So as not to obscure the disclosure with details that will readily be apparent to those skilled in the art, certain conventional elements and steps have been presented with lesser detail, while the drawings and specification describe in greater detail other elements and steps pertinent to understanding the invention.

The following embodiments are not intended to define limits as to the structure or method of the invention, but only to provide exemplary constructions. The embodiments are permissive rather than mandatory and illustrative rather than exhaustive.

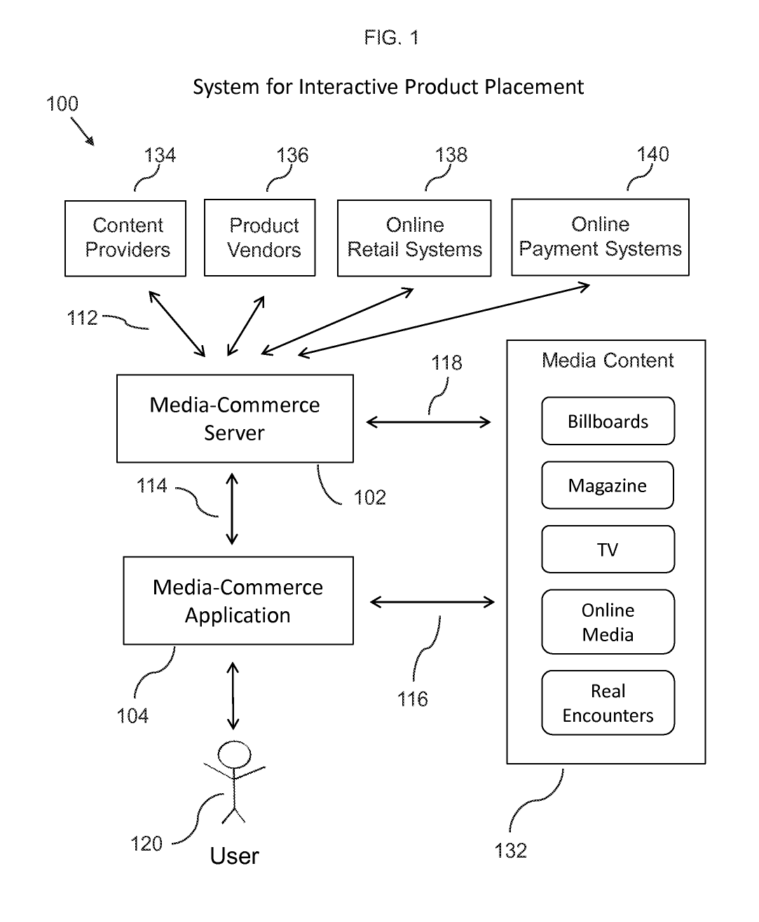

In the following, we describe the structure of an embodiment of a system for interactive product placement 100 with reference to FIG. 1, in such manner that like reference numerals refer to like components throughout; a convention that we shall employ for the remainder of this specification.

In an embodiment, a system for interactive product placement 100, can be comprised of:
a) a media-commerce server 102;
b) a media-commerce application 104, wherein the media-commerce application 104 can communicate with the media-commerce server 102 via a network connection 114, which for example can be the public Internet;
wherein
content providers 134 and product vendors 136, can update the media-commerce server 102 with information associating each media content item, such as a movie or TV-show, with lists of products and services, and wherein further
the media-commerce application can match media content that a user 120 is watching, by recording or capturing a media sample, such as an audio recording, a picture or a video, from media content 132 obtained via a media input channel 116.

In related embodiments, content providers 134 can for example be movie studios, marketing and media companies, and product vendors 136 can for example be wholesalers, manufacturers, and brand companies.

Media content 132 can be produced and provided by content providers 134, and can for example be television programs, movies, video games, billboards, magazines, and online media. Alternatively, media content 132 can be objects or products seen in real encounters in the physical environment. A user can for example take a media sample, in the form of a picture or video, from a real encounter while walking down a street, in a shop, in a hotel, etc.

A media content item can for example be a television show, a movie, an infomercial, a television ad, or other program shown on TV, online, or in other media.

In related embodiments, the media input channel 116, can be camera or microphone components that can record a media sample in the form of a video, audio or picture via the input/output 306 for storage in the memory 304. This can for example allow a user 120 to record a video or take a picture of his or her surroundings, or of a show or program, he or she is watching. The media input channel 116 can also include a network connection wherein the user is watching an online video stream or listening to an online audio stream.

In a further related example embodiment, a user can watch a movie or other online video stream on a mobile device, while the media input channel 116 concurrently transfers a recording, an image, an audio recording, or a video stream to the media commerce application 104.

In a related embodiment, the media-commerce server 102 can obtain online media samples directly from online forms of media content 132 via a media communication channel 118. This can for example allow the media commerce application 104 to redirect a live video stream from transmission via the media input channel 116, so that the video stream is received directly by the media-commerce server 102 via the media communication channel 118.

A product item shall be defined to mean a physical product or a service, or a combination of a product and a service.

In a related embodiment, the media-commerce server 102 can integrate with online retail systems 138, to create a seamless shopping experience for the consumer. The media-commerce server 102 can be configured with shopping cart functionality to aggregate multiple product items from various vendors, and can complete a transaction across a plurality of online retail systems 138, without requiring consumers to checkout multiple times.

In a related embodiment, the media-commerce server 102 can integrate with online payment systems 140, In order to process payments across various payment processors that are associated with the online retail systems 138.

In an embodiment, a media-commerce server 102 can be comprised of:
a) A processor 202;
b) A non-transitory memory 204;
c) An input/output component 206;
d) A content accumulator 210;
e) A content repository 212;
f) A content matcher 214;
g) An aggregated shopping cart 216;
h) A social media API 218; and
i) An external web portal 219; all connected via
j) A data bus 220.

In a related example embodiment, a user while watching TV a user can launch the media-commerce application 104, which can recognize a show being televised on TV, via the content matcher 214 processing an audio recording of the show.

In a related embodiment, the media-commerce application 104 can display various product categories related to the televised programming. Such information is provided by the aggregated shopping cart 216, retrieving information from the content repository 212.

In a related embodiment, the content repository 212 can store catalogues for every product item displayed in a program, such as a television show, including both products and services that can be associated to the programming. A program can be associated with an audio recording, to identify the show, and a list of product items. For example, if programming displays a house being painted, the application can propose house-painting services in the user's area, and can display product items for sale related to home painting and other do-it-yourself home improvement. The catalogue can be created for all possible product items being shown. In a further example, if a homebuilder's show is being televised, the system can display a catalogue related to the products used on the show, as well as clothing and accessories worn by the cast.

In a further related embodiment, catalogues can be organized in a plurality of different categories. A category can for example include product items by cast member, by popularity, by rating, by a type hierarchy, etc.

In a further related embodiment, catalogues can contain the same product items as exhibited in the media content 132, or alternative, closely matched, similar product items.

In a related embodiment, the content repository 212 of the media-commerce server 102, can be configured to include the following functions:
a) Store media content items, including video and audio files, such that each media content item is with a set of product items, including products and services.

In a related embodiment, the content accumulator 210 of the media-commerce server 102, can be configured to:
a) Capture media content items, including video and audio files, in communication with external content providers 134;
b) Capture individual product items that can be associated with specific media content items, in communication with external product vendors 134;
Wherein the captured media content and association with products items is stored in the content repository 212.

In a related embodiment, the content matcher 214 of the media-commerce server 102, can be configured to:
a) Match an input media sample, such as a captured or streaming video and/or audio file, to a media content item in the content repository; wherein the matching function can be provided by well-known matching algorithms for video or audio contents, such as for example provided by OpenCV and Echoprint libraries;
b) Match a video file by matching a sound track produced by video file, using well-known methods for matching audio signals;

In a related embodiment, the functionality of the content matcher 214 can be configured to operate in the media-commerce application 104, whereby the functionality can execute locally on a user device, such as a smartphone or tablet.

In a related embodiment, the aggregated shopping cart 216 can be configured to integrate shopping cart functionality of a plurality of online retail systems 138, such that the media-commerce server 102 can aggregate a plurality of product items from the plurality of online retail systems 138, and can complete a single transaction with the plurality of online retail systems 138.

In a related embodiment, the aggregated shopping cart 216 can be configured to integrate payment of a plurality of online payment systems 140, such that the media-commerce server 102 can process payments for a plurality of product items from a plurality of online retail systems 138.

In a related embodiment, the social media API 218 can be configured to allow a user to share media samples with friends on external social media services, such as Facebook, Twitter, Instagram, etc., whereby the friends can respond with likes/dislikes, commenting, etc.

In a further related embodiment, the social media API 218 can allow a user to follow an actor, musician or other celebrity, and receive notices or messages on when the celebrity appears in television shows or other programs. Such notices can also be made as calendar entries in the user's personal calendar.

In a related embodiment, the external web portal 219 can be configured to:
a) Provide an input interface for content providers 134 to input information about their media content 132, for storage in the content repository 212;
b) Provide a manual input interface for product vendors 136 to input information about their product items, and associate the product items with media content 132; such that the product items and links to media content is stored in the content repository 212;
c) Provide an automated input interface for product vendors 136 to input information about their product items, and associate the product items with media content 132; such that the product items and links to media content items is stored in the content repository 212. The input interface can for example in related embodiments interface directly with Enterprise Resource Planning (ERP) systems operated by the product vendors 136.
d) Provide a website that can display catalogues of products related to particular shows, so users can purchase directly online, potentially without using a mobile device;
e) Provide access to manage all connectivity functions, including:
   i. web services errors;
   ii. mobile simulator, showing how media-commerce application 104 will display their product items on mobile app before it gets published;
   iii. analytics and general accounting functions, such as invoicing.

In an embodiment, the media-commerce application 104 can be comprised of:
a) A processor 302;
b) A non-transitory memory 304;
c) An input/output component 306;
d) A content browser 310;
e) A shopping manager 312; all connected via
f) A data bus 320
Wherein the content browser 310 can be configured to allow a user 120 to browse and select products and services that have been received in communication with the content repository 212 of the media-commerce server 102; and
wherein further the shopping manager 312 can be configured to allow the user 120 to manage the selected products and services, and conduct purchasing transactions via communication with the aggregated shopping cart 216 of the media-commerce server 102.

In a related embodiment, the media-commerce application 104 can identify the program that a user is watching, by making a recording; receiving or re-directing a media stream, such as streaming video; or taking a picture of the program, and communicating the recording, the stream, or the picture, to the content matcher 214 of the media-commerce server 102. Once the program is identified, the media-commerce application can obtain the associated product and services in communication with the content repository 212, for processing in the content browser 310 and shopping manager 312.

In a related embodiment, the media-commerce application 104 via the input/output component 306 can use the mobile camera on a mobile device for taking a picture of a product, so that subsequently the picture can be communicated to the content matcher 214 of the media-commerce server 214 in order to match and identify exact and similar product items, whereby a user can learn more about the product item and potentially purchase the product item, wherein the purchase transaction is executed in the media-commerce application 104, without rerouting the user to external systems. The product item can for example be shoes that someone is wearing, a lamp seen in a hotel, etc.

In a related embodiment, the media-commerce application 104 can process media samples, such as MP4, MP3, WAV, and similar files, and send a request to the content matcher 214 of the media-commerce server 102, in order to identify products contained in the media samples, such as for example lamps, shoes, suits, jewelry, tiles, etc. The content matcher 214 can extract specific images from a movie, then match those images products in the content repository 212 and create an association between the movie and the product, which is stored by the content repository 212 in the memory 204.

In a further related embodiment, the video and audio input can be either pre-recorded or retrieved as a live stream via the input/output 206.

In a further related embodiment, the media-commerce application 104 can use geo positioning to determine the location of a user, which can be used as an additional parameter by the content matcher 214, to identify matching products, by only showing product items that are within a predetermined distance of the user. If a product item is marked as location agnostic, this product can optionally still be shown regardless of distance, which for example can be relevant for large online retailers that ship nationwide. This functionality can be used to identify service offerings, but can also be used to identify to find optimal “ship-from” location for shipping. For example: if user is in Atlanta, Ga. and product offering is from Macy's, the store could select to ship product from an Atlanta store instead of from a South East distribution warehouse.

In a related embodiment, the media-commerce application 104 can execute on a mobile device, concurrently with performing other functions the mobile device, including viewing of video files, listening to audio recording, etc.

In related embodiments, both the media-commerce server 102 and the media-commerce application 104 can each respectively operate as standalone connected components, or they can be embedded within other external applications, systems, or business solutions. The media-commerce application 104 can for example be a web browser plug-in, a web site or web application, a mobile app; or it could be an embedded component operating within a smart TV.

In related embodiments, the media-commerce server 102 and the media-commerce application 104 can each respectively be part of a general computer, such as a personal computer (PC), a tablet, a notebook, a laptop, a workstation, a server, a mainframe computer, a smart phone, a mobile device, a smart television, an embedded processor in a vehicle, machine, or building structure, a similar device, or some combination of these. Such a general computer can include a memory, a processor, input/out components, and other components that are common for general computers, all of which are well known in the art and therefore will not be further elaborated or described herein.

In related embodiments, the media-commerce application 104 can include:
a) a web application, executing in a Web browser;
b) a tablet app, executing on a tablet device, such as for example an Android or iOS tablet device;
c) a mobile app, executing on a mobile device, such as for example an Android phone or iPhone, or any wearable mobile device;
d) a desktop application, executing on a personal computer, or similar device;
e) an embedded application, executing on a processing device, for example in a kiosk, a smart TV, or other system.

It shall be understood that an executing instance of an embodiment of the system for interactive product placement 100, as shown in FIG. 1, can include a plurality of media-commerce applications 104, which are each tied to one or more users 120.

An executing instance of an embodiment of system for interactive product placement 100, as shown in FIG. 1, can similarly include a plurality of media-commerce servers 102.

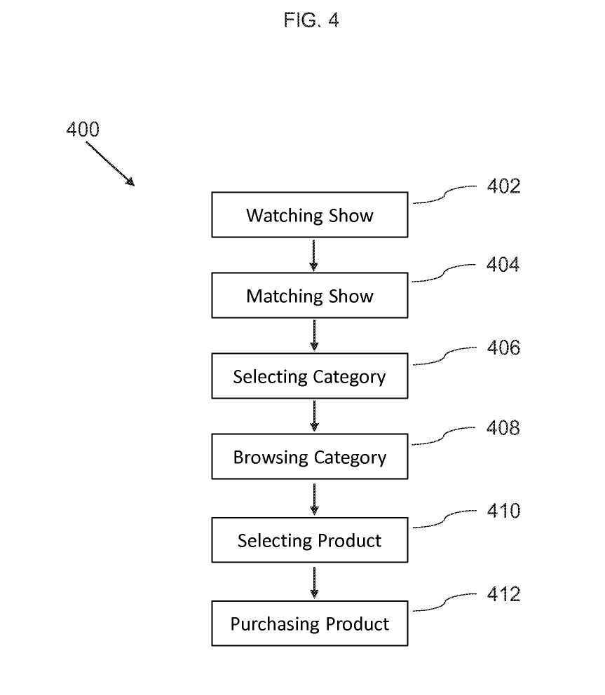

A computer-implemented method for interactive product placement 400, as illustrated in FIG. 4, can comprise:
a) watching media content 402; wherein a user can watch a first show;
b) matching media content 404, wherein the first show is matched with a selected show from a list of pre-determined shows, wherein each pre-determined show is associated with a list of products and a list of services, such that a list of products and a list of services associated with the first show can be selected;
c) Selecting category 406, wherein the user selects a category from a list of product and service categories;
d) Browsing category 408, wherein the user browses a selected list of products or services that are associated with the category and the first show;
e) Selecting 410, wherein the user selects one or more selected product items from the selected list of products and services; and
f) Purchasing 412, wherein the user purchases the selected product items via an online sales transaction;
   i. Optionally, if the product item is a service, the user can send an automated or manual service request form to the product vendor 136 associated with the product item.

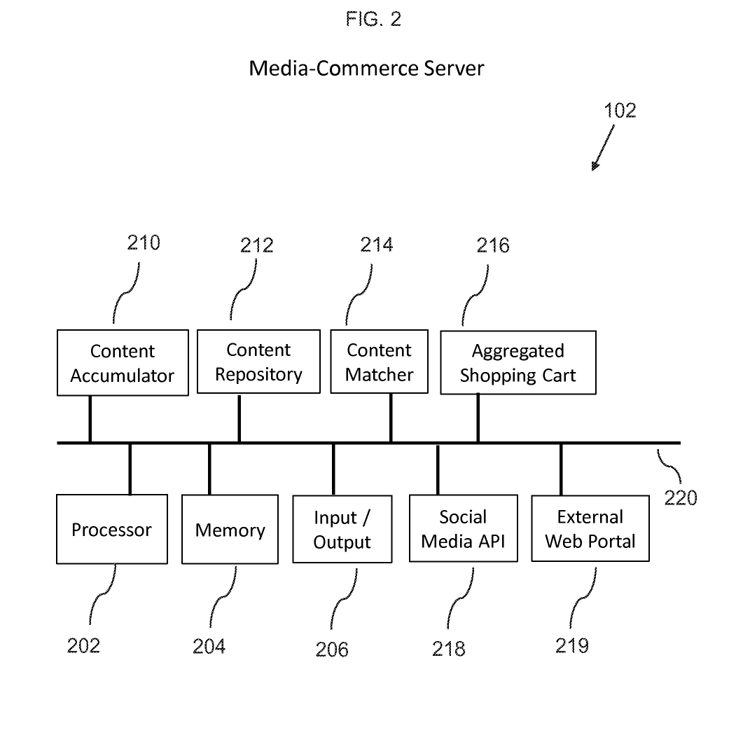

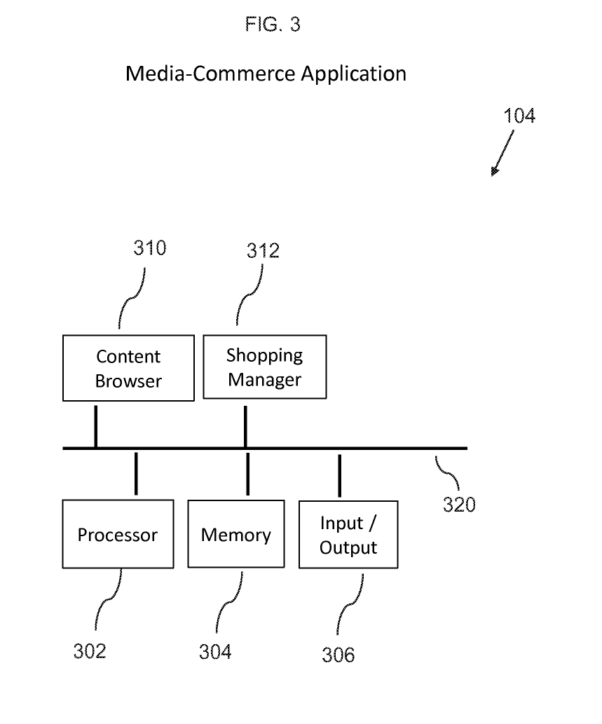

FIGS. 1, 2, 3 and 4 are block diagrams and flowcharts methods, devices, systems, apparatuses, and computer program products according to various embodiments of the present invention. It shall be understood that each block or step of the block diagram, flowchart and control flow illustrations, and combinations of blocks in the block diagram, flowchart and control flow illustrations, can be implemented by computer program instructions or other means. Although computer program instructions are discussed, an apparatus or system according to the present invention can include other means, such as hardware or some combination of hardware and software, including one or more processors or controllers, for performing the disclosed functions.

In this regard, FIGS. 1, 2, and 3 depict the computer devices of various embodiments, each containing several of the key components of a general-purpose computer by which an embodiment of the present invention may be implemented. Those of ordinary skill in the art will appreciate that a computer can include many components. However, it is not necessary that all of these generally conventional components be shown in order to disclose an illustrative embodiment for practicing the invention. The general-purpose computer can include a processing unit and a system memory, which may include various forms of non-transitory storage media such as random access memory (RAM) and read-only memory (ROM). The computer also may include nonvolatile storage memory, such as a hard disk drive, where additional data can be stored.

FIG. 1 shows a depiction of an embodiment of the system for interactive product placement 100, including the media-commerce server 102. In this relation, a server shall be understood to represent a general computing capability that can be physically manifested as one, two, or a plurality of individual physical computing devices, located at one or several physical locations. A server can for example be manifested as a shared computational use of one single desktop computer, a dedicated server, a cluster of rack-mounted physical servers, a datacenter, or network of datacenters, each such datacenter containing a plurality of physical servers, or a computing cloud, such as Amazon EC2 or Microsoft Azure.

It shall be understood that the above-mentioned components of the media-commerce server 102 and media-commerce application 104 are to be interpreted in the most general manner.

For example, the processor 202 and the processor 302 can each respectively include a single physical microprocessor or microcontroller, a cluster of processors, a datacenter or a cluster of datacenters, a computing cloud service, and the like.

In a further example, the memory 204 and the memory 304 can each respectively include various forms of non-transitory storage media, including random access memory and other forms of dynamic storage, and hard disks, hard disk clusters, cloud storage services, and other forms of long-term storage. Similarly, the input/output 206 and the input/output 306 can each respectively include a plurality of well-known input/output devices, such as screens, keyboards, pointing devices, motion trackers, communication ports, and so forth.

Furthermore, it shall be understood that the media-commerce server 102 and the media-commerce application 104 can each respectively include a number of other components that are well known in the art of general computer devices, and therefore shall not be further described herein. This can include system access to common functions and hardware, such as for example via operating system layers such as Windows, Linux, and similar operating system software, but can also include configurations wherein application services are executing directly on server hardware or via a hardware abstraction layer other than a complete operating system.

An embodiment of the present invention can also include one or more input or output components, such as a mouse, keyboard, monitor, and the like. A display can be provided for viewing text and graphical data, as well as a user interface to allow a user to request specific operations. Furthermore, an embodiment of the present invention may be connected to one or more remote computers via a network interface. The connection may be over a local area network (LAN) wide area network (WAN), and can include all of the necessary circuitry for such a connection.

In related embodiments, the media-commerce server 102 communicates with content providers 134, product vendors 136, and online retail systems 138 over a network 112, which can include the general Internet, a Wide Area Network or a Local Area Network, or another form of communication network, transmitted on wired or wireless connections. Wireless networks can for example include Ethernet, Wi-Fi, Bluetooth, ZigBee, and NFC. The communication can be transferred via a secure, encrypted communication protocol.

In related embodiments, the media-commerce server 102 communicates with the media-commerce application 104 over a network 114, which can include the general Internet, a Wide Area Network or a Local Area Network, or another form of communication network, transmitted on wired or wireless connections.

In related embodiments, the media-commerce server 102 communicates with online media content over a media communication channel 118, which can include the general Internet, a Wide Area Network or a Local Area Network, or another form of communication network, transmitted on wired or wireless connections.

Typically, computer program instructions may be loaded onto the computer or other general-purpose programmable machine to produce a specialized machine, such that the instructions that execute on the computer or other programmable machine create means for implementing the functions specified in the block diagrams, schematic diagrams or flowcharts. Such computer program instructions may also be stored in a computer-readable medium that when loaded into a computer or other programmable machine can direct the machine to function in a particular manner, such that the instructions stored in the computer-readable medium produce an article of manufacture including instruction means that implement the function specified in the block diagrams, schematic diagrams or flowcharts.

In addition, the computer program instructions may be loaded into a computer or other programmable machine to cause a series of operational steps to be performed by the computer or other programmable machine to produce a computer-implemented process, such that the instructions that execute on the computer or other programmable machine provide steps for implementing the functions specified in the block diagram, schematic diagram, flowchart block or step.

Accordingly, blocks or steps of the block diagram, flowchart or control flow illustrations support combinations of means for performing the specified functions, combinations of steps for performing the specified functions and program instruction means for performing the specified functions. It will also be understood that each block or step of the block diagrams, schematic diagrams or flowcharts, as well as combinations of blocks or steps, can be implemented by special purpose hardware-based computer systems, or combinations of special purpose hardware and computer instructions, that perform the specified functions or steps.

As an example, provided for purposes of illustration only, a data input software tool of a search engine application can be a representative means for receiving a query including one or more search terms. Similar software tools of applications, or implementations of embodiments of the present invention, can be means for performing the specified functions. For example, an embodiment of the present invention may include computer software for interfacing a processing element with a user-controlled input device, such as a mouse, keyboard, touch screen display, scanner, or the like. Similarly, an output of an embodiment of the present invention may include, for example, a combination of display software, video card hardware, and display hardware. A processing element may include, for example, a controller or microprocessor, such as a central processing unit (CPU), arithmetic logic unit (ALU), or control unit.

The many features and advantages of the invention are apparent from the detailed specification, and thus, it is intended by the appended claims to cover all such features and advantages of the invention, which fall within the true spirit and scope of the invention.

For example, alternative embodiments can reconfigure or combine the components of the media-commerce server 102 and the media-commerce application 104. The components of the media-commerce server 102 can be distributed over a plurality of physical, logical, or virtual servers. Parts or all of the components of the media-commerce application 104 can be configured to operate in the media-commerce server 102, whereby the media-commerce application 104, functions as a thin client, performing only graphical user interface presentation and input/output functions. Alternatively, parts or all of the components of the media-commerce server 102 can be configured to operate in the media-commerce application 104.

Many such alternative configurations are readily apparent, and should be considered fully included in this specification and the claims appended hereto. Accordingly, since numerous modifications and variations will readily occur to those skilled in the art, it is not desired to limit the invention to the exact construction and operation illustrated and described, and thus, all suitable modifications and equivalents may be resorted to, falling within the scope of the invention.

What is claimed is:

1. A system for interactive product placement, comprised of:
a) a media-commerce server; and
b) a media-commerce application, wherein the media-commerce application can communicate with the media-commerce server via a network connection;
wherein
content providers and product vendors can update the media-commerce server with information associating media content, with lists of products and services; and wherein further
the media-commerce application can match media content that a user is watching, by recording or capturing a media sample from the media content.

2. The system for interactive product placement of claim 1, wherein the media-commerce server further comprises a content repository; wherein the content repository is configured to store in non-transitory memory a list of media content items, such that each media content item is associated with a list of products and services.

3. The system for interactive product placement of claim 2, wherein the media-commerce server further comprises a content matcher, wherein the content matcher is configured to match an input media sample with a media content item stored in the content repository, such that the products and services associated with the input media sample can be selected.

4. The system for interactive product placement of claim 3, wherein the content matcher is further configured to match an input video file, by matching a soundtrack associated with the input video file, such that the soundtrack is matched with a corresponding audio sample in the content repository.

5. The system for interactive product placement of claim 3, wherein the content matcher is further configured to match an input image with a corresponding media content item in the content repository.

6. The system for interactive product placement of claim 2, wherein the media-commerce server further comprises a content accumulator, wherein the content accumulator can be configured to:
capture media content items in communication with external content providers, and store the media content items in the content repository; and
capture individual products and services and associate each individual product or service with a stored media content item in communication with external product vendors.

7. The system for interactive product placement of claim 1, wherein the media-commerce server further comprises an aggregated shopping cart, wherein the aggregated shopping cart is configured to integrate shopping cart functionality of a plurality of online retailers, such that the media-commerce server can aggregate a plurality of product items from the plurality of online retailers, and the media-commerce server can complete a single transaction with the plurality of online retailers.

8. The system for interactive product placement of claim 1, wherein the media sample further comprises a live video stream.

9. A media-commerce server, comprised of:
a) a processor;
b) a non-transitory memory;
c) an input/output component; and
d) a content repository;
wherein the content repository is configured to store in the non-transitory memory a list of media content items, such that each media content item is associated with a list of products and services.

10. The media-commerce server of claim 9, further comprising a content matcher, wherein the content matcher is configured to match an input media sample with a media content item stored in the content repository, such that the products and services associated with the media content item can be selected.

11. The media-commerce server of claim 10, wherein the content matcher is further configured to match an input video file, by matching a soundtrack associated with the video file, such that the sound track is matched with a corresponding audio sample in the content repository.

12. The system for interactive product placement of claim 10, wherein the content matcher is further configured to match an input image with a corresponding media content item in the content repository.

13. The media-commerce server of claim 9, further comprising a content accumulator, wherein the content accumulator can be configured to:
capture media files in communication with external content providers, and store the media files in the content repository; and
capture individual products and services and associate each individual product or service with a stored media file in communication with external product vendors.

14. The media-commerce server of claim 9, further comprising an aggregated shopping cart, wherein the aggregated shopping cart is configured to integrate shopping cart functionality of a plurality of online retailers, such that the media-commerce server can aggregate a plurality of product items from a plurality of online retailers, and the media-commerce server can complete a single transaction with the plurality of online retailers.

15. The media-commerce server of claim 10, wherein the input media sample further comprises a live video stream.

16. A computer-implemented method for interactive product placement, comprising:
a) watching media content, wherein a user watches a first show and
b) matching media content, wherein the first show is matched with a selected show from a list of pre-determined shows, wherein each pre-determined show is associated with a list of products and a list of services, such that a list of products and a list of services associated with the first show can be identified.

17. The computer-implemented method for interactive product placement of claim 16, further comprising:
c) selecting category, wherein the user selects a category from a list of product and service categories.

18. The computer-implemented method for interactive product placement of claim 17, further comprising:
d) browsing category, wherein the user browses a selected list of products and services that are associated with the category, and are associated with the first show.

19. The computer-implemented method for interactive product placement of claim 18, further comprising:
e) selecting product items, wherein the user selects one or more selected product items from the selected list of products and services.

20. The computer-implemented method for interactive product placement of claim 19, further comprising:
f) purchasing product items, wherein the user purchases the selected product items via an online sales transaction.

21. The computer-implemented method for interactive product placement of claim 20, wherein the act of purchasing the selected product items further comprises completing purchase transactions with a plurality of e-commerce systems.

22. The computer-implemented method for interactive product placement of claim 16, wherein the act of matching media content further comprises matching an input video file of the first show, by matching a first audio track of the input video file, such that the first audio track is matched with a corresponding audio track of a show in the list of pre-determined shows.

23. The computer-implemented method for interactive product placement of claim 16, wherein the act of matching media content further comprises matching an input image associated with the first show with a corresponding video of a show in the list of pre-determined shows.
